(19) United States
(12) Patent Application Publication
(10) Pub. No.: US 2011/0209625 A1
(43) Pub. Date: Sep. 1, 2011

(54) BABY FORMULA MAKER

(76) Inventor: Mi Seon Kang, Songpa-gu (KR)

(21) Appl. No.: 12/753,172

(22) Filed: Apr. 2, 2010

(30) Foreign Application Priority Data
Feb. 26, 2010 (KR) 10-2010-0017876

(51) Int. Cl. A47J 31/40; A47J 36/24

(52) U.S. Cl. 99/323.3; 222/144.5; 222/146.1

(57) ABSTRACT

Provided is a baby formula maker including: a body for accommodating a water container and a powered formula container; a heater installed in the body and for heating water contained in the water container; a cooler including a radiator for cooling the heated water by receiving the heated water from the heater, a heat sink combined with the radiator to cool down the radiator, and a cooling fan for increasing cooling efficiency of the heat sink; and an operator for controlling operations of the heater according to a temperature of the water contained in the water container. Accordingly, the baby formula maker provides speed and convenience since a baby formula is promptly made by remarkably reducing a baby formula making time. Moreover, the baby formula maker has a sanitary, compact, and simple structure, and is economical since it is mass-productible.

### CROSS-REFERENCE TO RELATED PATENT APPLICATION

This application claims the benefit of Korean Patent Application No. 10-2010-0017876, filed on Feb. 26, 2010, in the Korean Intellectual Property Office, the disclosure of which is incorporated herein in its entirety by reference.

### BACKGROUND OF THE INVENTION

1. Field of the Invention

The present invention relates to a baby formula maker, and more particularly, to a baby formula maker for conveniently and quickly making a baby formula.

2. Description of the Related Art

Generally, a newborn infant is nursed for a certain period of time after birth. Here, the newborn infant may be breast-fed, but mostly, may be bottle-fed with a baby formula made by mixing warm water and a powdered formula. In order to make the baby formula by mixing the powdered formula and warm water, sanitary water that is boiled first and then cooled down to a lukewarm state of a suitable temperature is prepared, the amount of the powdered formula is measured using a spoon, and the then the sanitary water and the powdered formula are mixed in a feeding bottle by shaking the feeding bottle. Then, the baby formula in the feeding bottle is fed to the newborn infant.

However, considering that the newborn infant needs to be fed several times a day, it is quite cumbersome to repeat the processes of making the baby formula. Specifically, it may be difficult to quickly feed the newborn infant because a lot of time is taken to boil and cool down water since water needs to be boiled hard to prepare suitably lukewarm water and then cooled down to a suitable temperature.

### SUMMARY OF THE INVENTION

The present invention provides a baby formula maker for simply and quickly making a baby formula.

According to an aspect of the present invention, there is provided a baby formula maker including: a body for accommodating a water container and a powered formula container; a heater installed in the body and for heating water contained in the water container; a cooler including a radiator for cooling the heated water by receiving the heated water from the heater, a heat sink combined with the radiator to cool down the radiator, and a cooling fan for increasing cooling efficiency of the heat sink; and an operator for controlling operations of the heater according to a temperature of the water contained in the water container.

The water container may be formed of stainless steel. The powdered formula container may include a powdered formula emitting switch for emitting a certain amount of powdered formula according to manipulation of a user. Also, the water container or the powdered formula container may be formed of a transparent material so that remaining amount of the water contained in the water container or the powdered formula contained in the powdered formula container may be checked from the outside.

The operator may be a bimetal switch, and may be connected to an opening and closing unit formed in the water container to open the opening and closing unit so that the water is supplied to the cooler when the water in the water container is heated by the heater up to a certain temperature.

Also, the heater may be a nicrome hot wire, and the radiator may be an aluminum pipe or a silicon tube.

### BRIEF DESCRIPTION OF THE DRAWINGS

The above and other features and advantages of the present invention will become more apparent by describing in detail the exemplary embodiments thereof with reference to the attached drawings in which:

FIG. 1 is an external perspective view of a baby formula maker according to an embodiment of the present invention;

FIG. 2 is a diagram illustrating a structure of the baby formula maker of FIG. 1; and

FIG. 3 is a diagram of a radiator illustrated in FIG. 2, according to another embodiment of the present invention.

### DETAILED DESCRIPTION OF THE INVENTION

Hereinafter, the present invention will be described more fully with reference to the accompanying drawings, in which exemplary embodiments of the invention are shown.

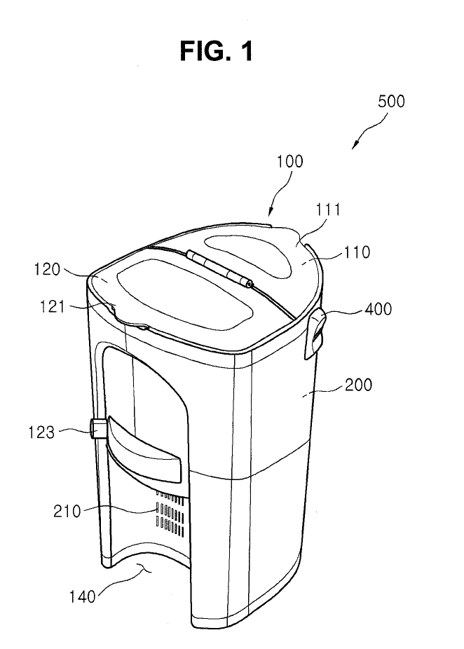

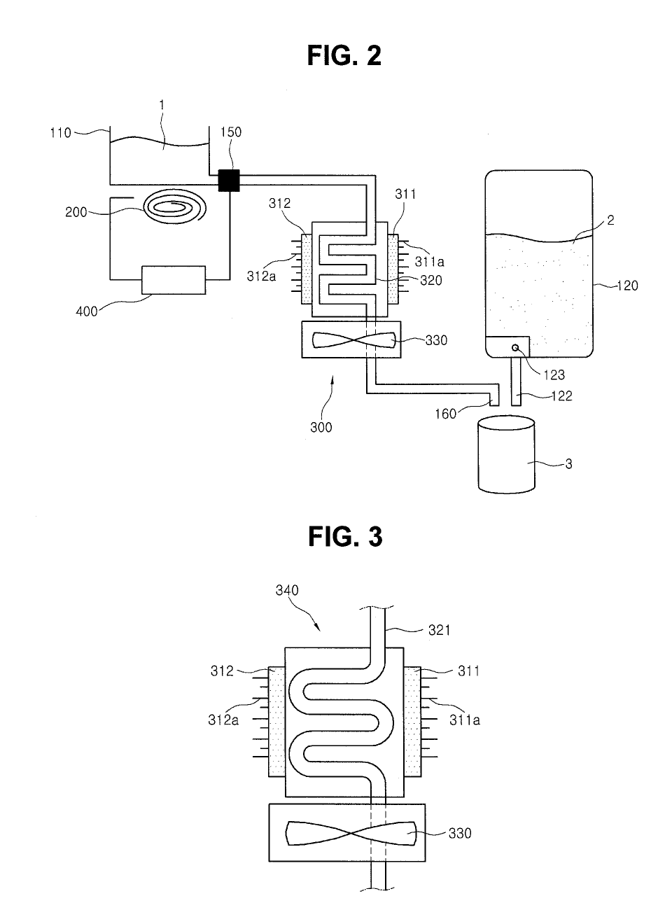

FIG. 1 is an external perspective view of a baby formula maker 500 according to an embodiment of the present invention, FIG. 2 is a diagram illustrating a structure of the baby formula maker 500 of FIG. 1, and FIG. 3 is a diagram of a radiator 320 illustrated in FIG. 2, according to another embodiment of the present invention.

First, referring to FIGS. 1 and 2, the baby formula maker 500 according to the current embodiment of the present invention includes a body 100, a heater 200, a cooler 300, and an operator 400.

The body 100 accommodates a water container 110 for containing water 1, and a powdered formula container 120 for containing powdered formula 2. In addition, a structure including the heater 200, the cooler 300, and the operator 400 is compactly accommodated in the body 100. Accordingly, the baby formula maker 500 has a small size, and thus is easily installed in a limited space. Also, a placing unit 140 for placing a bottle 3 is formed in front of the body 100.

The powdered formula container 120 and the water container 110 are built in the upper portion of the body 100, and the powdered formula 2 and the water 1 may be supplied to the powdered formula container 120 and the water container 110 through covers 121 and 111, respectively, wherein the covers 121 and 111 are prepared on the upper portion of the body 100. The covers 111 and 121 according to the current embodiment of the present invention are opened or closed from one side by using a hinge, but are not limited thereto as long as the powdered formula container 120 and the water container 110 are opened and closed. For example, the covers 111 and 121 may have a sliding door structure.

Meanwhile, the water container 110 is easily maintained, sanitary, durable, and thermostable, and is formed of stainless steel, which has excellent thermal conductivity so that the water 1 is quickly boiled by the heater 200. Here, the water container 110 may have small capacity of 300 ml so as to quickly boil the water 1 for a short heating time of within 30 seconds and to reduce the entire size of the water container 110.

The powdered formula container 120 includes a powdered formula emitting switch 123 for emitting a certain amount of the powdered formula 2 according to manipulation of a user. Here, the powdered formula emitting switch 123 is exposed to the outside the body 100 so that the user easily manipulates the powdered formula emitting switch 123 from the outside. Also, the powdered formula emitting switch 123 may be a lever type handle so that the certain amount of powdered formula 2 is emitted whenever the user rotates the powdered formula emitting switch 123 once to a first direction. The powdered formula emitting switch 123 according to the current embodiment of the present invention is a lever type, but is not limited thereto, and may be any type, such as a button type or a touch type.

The water container 110 or the powdered formula container 120 may be formed of a transparent material so that the remaining amount of the water 1 contained in the water container 110 or the powdered formula 2 contained in the powdered formula container 120 may be checked from the outside. In addition, the water container 110 and the powdered formula container 120 may have gradations so that the user may determine the remaining amount of the water 1 and the powdered formula 2.

Also, the water container 110 and the powdered formula container 120 may be conveniently separated from and assembled to the body 100 for easy cleaning, and the water container 110 and the powdered formula container 120 may be antibacterial.

The heater 200 is installed inside the body 100 to heat the water 1 contained in the water container 110, and may be a nicrome hot wire for quick heat up. According to the current embodiment of the present invention, 300 ml of water, i.e., the general capacity of the powdered formula container 120, may be quickly heated up to 100° C. within 10 to 30 seconds by the heater 200 using the nicrome hot wire.

The operator 400 controls the operations of the heater 200. The operator 400 initially activates the heater 200 while controlling the operations of the heater 200 according to the temperature of the water 1 contained in the water container 110. Here, the operator 400 may be a bimetal switch, and is exposed on an external side surface of the body 100 so that the user conveniently operates the operator 400 from the outside.

The operations of the operator 400 will now be described in detail. First, when the user activates the bimetal switch, the heater 200 is activated to heat the water 1 in the water container 110. Then, when the water 1 in the water container 110 reaches a certain temperature, i.e., boils, after some time, the bimetal switch is turned off. Then, an opening and closing unit 150 formed in the water container 110 is opened to supply the boiled water 1 in the water container 110 to the cooler 300. Here, the opening and closing unit 150 is configured to be connected to the bimetal switch, and opened when the bimetal switch is turned off. At this time, after all or a certain amount of water 1 in the water container 110 is transferred to the cooler 300, the opening and closing unit 150 is closed.

The cooler 300 receives the water 1 heated by the heater 200 from the opening and closing unit 150 and cools the water 1 down to a temperature suitable for nursing. The cooler 300 includes the radiator 320, heat sinks 311 and 312, and cooling fan 330.

The radiator 320 may be formed of aluminum having excellent thermal conductivity, and may curve in zigzags to increase contacting areas for excellent cooling efficiency.

Meanwhile, aside from the aluminum, the radiator 320 may be a silicon tube. FIG. 3 illustrates a radiator 321 applying a silicon tube. When the radiator 321 is used, a cooler 340 may be low-priced, have a small size, and have various shapes, compared to the radiator 320 formed of aluminum. Here, the silicon tube may be a sanitary material such as a pacifier for nursing a baby, may be thermostable to stand against the high temperature (about 100□) of the flowing water 1, and may curve in zigzags to increase contacting areas with the outside for excellent cooling efficiency.

The heat sinks 311 and 312 may be combined to each side of the radiator 320 or 321 to cool down the radiator 320 or 321, and may include a plurality of heat sink pins 311a and 312a, respectively. Also, in order to increase the cooling efficiency of the radiator 320 or 321, the heat sinks 311 and 312 may be adhered to respective sides of the radiator 320 or 321. However, the locations of the heat sinks 311 and 312 are not limited thereto, and a plurality of heat sinks may be installed at one side or various locations of the radiator 320 or 321, or the heat sinks 311 and 312 may surround the radiator 320 or 321 according to an internal space of the body 100, a length of the radiator 320 or 321, capacity of the flowing water 1, and a target temperature to be cooled down within a given time.

The cooling fan 330 cools down the radiator 320 or 321 and the heat sinks 311 and 312 so as to increase the cooling efficiency of the heated water 1, and is disposed at the lower portion (latter part) of the radiator 320 or 321 and the heat sinks 311 and 312. However, the location of the cooling fan 330 is not limited thereto and may vary.

As described above, according to the current embodiment of the present invention, the heated water 1 may be quickly cooled down by the cooler 300 including the radiator 320 or 321, the heat sinks 311 and 312, and the cooling fan 330. Accordingly, a baby formula making time may be remarkably reduced, and the baby formula maker is economical since it has a simple structure and is easy to handle.

Meanwhile, the baby formula maker according to the current embodiment of the present invention further includes a powdered formula outlet 122 and a water outlet 160 to emit the cooled water 1 and the powdered formula 2 to the bottle 3 located in the placing unit 140 of the body 100. The body 100 may include various electrical structures, such as a lamp, a thermometer, etc. considering convenience of the user. The structures of the electrical structures may vary, and the exterior of the baby formula maker, such as the structure and shape of the body 100, and other elements excluding important elements of the current embodiment of the present invention may vary according to a design or capacity desired by the user as long as it is within the scope of the invention. A reference numeral 210 denotes a cooling hole formed on the body 100.

A method of making a baby formula by using the baby formula maker of FIG. 1, according to an embodiment of the present invention will now be described in detail.

First, the user puts the powered formula 2 in the powdered formula container 120, and the water 1, for example, from about 100 ml to about 250 ml, which is required to be mixed with the powdered formula 2, in the water container 110. Then, the user locates the bottle 2 in the placing unit 140 in such a way that an opening of the bottle 3 is disposed below the powdered formula outlet 122 and the water outlet 160 to receive the cooled water 1 and the powdered formula 2, which are respectively emitted from the water outlet 160 and the powdered formula outlet 122.

When the powdered formula container 120 and the water container 110 are filled with the powdered formula 2 and the water 1 respectively, the heater 200 is activated by pressing a bimetal switch, i.e., an operating switch.

When the water 1 in the water container 110 is heated by the heater 200, the bimetal switch is turned off, and then the heated water 1 is supplied to the cooler 300 as the opening and closing unit 150 is opened.

The heated water 1 supplied from the heater 200 is cooled down by the cooler 300 to a temperature suitable to make a baby formula, and then the cooled down water 1 is emitted through the water outlet 160.

When all the water 1 is emitted from the cooler 300, the user turns a lever, i.e., the powdered formula emitting switch 123 included in the body 100 to emit a desired amount of powdered formula 2. The emitted water 1 and powdered formula 2 are contained in the bottle 3, and the user may shake the bottle 3 to make a baby formula.

As described above, the baby formula maker 500 according to the embodiments of the present invention remarkably reduces the time required for a series of baby formula making processes of boiling the water 1, cooling down the water 1 to the temperature suitable to be bottle-fed, and then mixing the water 1 with the powdered formula 2 down to about 2 minutes. Accordingly, since a baby may be promptly bottle-fed within a short time whenever the baby formula is required, the baby formula maker 500 provides speed and convenience to the user. Also, since the water 1 is boiled, a sterilization and pasteurization effect is secured, and thus the baby is bottle-fed safely and the baby formula is sanitary. In addition, important elements including the cooler 300 are easily handled and have low production costs due to their simple structures. Accordingly, the baby formula maker 500 is mass-productible with low costs, and thus consumers may purchase the baby formula maker 500 at a low price.

By using the baby formula maker according to the present invention, the baby formula making time can be remarkably reduced and thus the baby formula may be immediately made whenever it is needed, thereby providing speed and convenience. Moreover, the baby formula maker has a sanitary, compact, and simple structure, and thus is economical as it is mass-productible.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-5. (canceled)

6. A baby formula maker comprising:
a body for accommodating a water container and a powered formula container;
a heater installed in the body for heating water contained in the water container;
a cooler comprising:
a radiator for cooling the heated water by receiving the heated water from the heater,
a heat sink combined with the radiator to cool down the radiator, and
a cooling fan for increasing cooling efficiency of the heat sink; and
an operator for controlling operations of the heater according to a temperature of the water contained in the water container.

7. The baby formula maker of claim 6, wherein the water container is formed of stainless steel.

8. The baby formula maker of claim 6, wherein the powdered formula container comprises a powdered formula emitting switch for emitting a certain amount of powdered formula in response to manipulation of the switch by a user.

9. The baby formula maker of claim 6, wherein the operator is a bimetal switch, and is connected to an opening and closing unit formed in the water container to open the opening and closing unit so that the water is supplied to the cooler when the water in the water container is heated by the heater up to a certain temperature.

10. The baby formula maker of claim 6, wherein the radiator is an aluminum pipe.

11. The baby formula maker of claim 6, wherein the radiator is a silicon tube.
